(19) United States
(12) Patent Application Publication
(10) Pub. No.: US 2015/0026462 A1
(43) Pub. Date: Jan. 22, 2015

(54) METHOD AND SYSTEM FOR ACCESS-CONTROLLED DECRYPTION IN BIG DATA STORES

(71) Applicant: Dataguise, Inc., Fremont, CA (US)

(72) Inventors: Subramanian Ramesh, San Jose, CA (US); Harinder Singh Bedi, Mohali (IN); Varun Kashyap, Fremont, CA (US)

(73) Assignee: DATAGUISE, INC.

(21) Appl. No.: 14/304,902

(22) Filed: Jun. 14, 2014

Related U.S. Application Data
(63) Continuation-in-part of application No. 14/218,945, filed on Mar. 18, 2014.
(60) Provisional application No. 61/794,680, filed on Mar. 15, 2013.

(51) Int. Cl. G06F 21/62

(52) U.S. Cl. CPC G06F 21/6218
USPC 713/165

(57) ABSTRACT

A method and system for access-controlled decryption in big data stores is provided. In an implementation, a system provides a method for encryption that stores meta-information about sensitive data elements being encrypted in a big data store, such as a Hadoop system, in which the bulk of the data may remain unencrypted. In an implementation, the system reads the stored meta-information at decryption time to determine where the encrypted data is within a large and unencrypted file system, and to determine whether or not an individual user has access rights to decrypt a given element of sensitive data. The system allows fine-grain control over access rights to sensitive data during decryption.

### RELATED APPLICATIONS

This continuation-in-part application claims the benefit of priority to U.S. patent application Ser. No. 14/218,945 filed Mar. 18, 2014, and incorporated by reference herein in its entirety; which in turn claims the benefit of priority to U.S. Provisional Patent Application No. 61/794,680 filed Mar. 15, 2013, and incorporated by reference herein in its entirety.

### FIELD OF THE INVENTION

This disclosure generally relates to access control in very large data stores. More specifically, this disclosure relates to access rights of individual users for permitting decryption of sensitive content within a big data store, and methods of encryption that allow fine-grain control over the access rights during decryption.

### BACKGROUND OF THE INVENTION

As the amount of data being captured and analyzed by enterprises across the globe increases exponentially, new technologies have emerged to manage the quantum of data. The new data is orders of magnitude larger than the data previously managed by enterprises in traditional relational databases and standard non-distributed file systems. This patent application refers to these stores as “big data stores”. There are a variety of systems, ranging from Hadoop® and distributed key-value stores such as HBase, to NoSQL systems such as Couchbase® and MongoDB® that implement the ability to store big data, typically using highly parallel storage mechanisms on commodity hardware.

Big data stores are often used to store data collected from the web, such as Twitter® feeds and Facebook® conversations, call records from call centers and telephones, transaction data for financial institutions, and weather data. Big data stores generally house a wide variety of information, and are accessed by a variety of end users within corporations. As a result, discovery, identification, protection of sensitive data, and control and monitoring of access to the data within big data store are of utmost importance for an enterprise.

The sensitive data referred to above may include one or more of, but is not limited to, bank account numbers, passwords, case histories, and personal/professional communication data such as instant message and email data, bank transaction data, and security codes. The sensitive data is valuable, and therefore should be appropriately protected. Enterprises employ various techniques to protect the sensitive data from being exposed. In order to secure a piece of sensitive data, it is critical to correctly identify such data in a data store. Existing techniques identify sensitive data based on one or more of, but not limited to, predefined users, predefined data types, or predefined data owners, and predefined state of the data.

The existing techniques address data in databases, traditional file systems, and similar data stores that have limited parallel processing capabilities, and limited storage capacities compared with the new highly distributed file systems (DFSs), such as Hadoop® Distributed File Systems. The existing techniques do not take advantage of the parallel processing provided by the new systems, and therefore will not scale to the data sizes supported by the new DFSs. Some new techniques for discovering and masking sensitive data in highly distributed data stores are the subject of U.S. patent application Ser. No. 13/834,947, entitled, “Method and System for Masking Sensitive Data in a Distributed File System,” U.S. patent application Ser. No. 14/216,840, entitled, “Method and System for Managing and Securing Subsets of Data in a Large Distributed Data Store,” and U.S. patent application Ser. No. 14/218,945, entitled, “Method and System for Entitlement Setting, Mapping, and Monitoring in Big Data Stores,” each of these incorporated by reference herein in their entireties.

Having identified where sensitive data resides, it is important to either mask or encrypt the data if the business use case requires it. This description addresses the case where encryption is the chosen method of protection, and provides access-controlled decryption of encrypted sensitive data.

### BRIEF DESCRIPTION OF THE DRAWINGS

FIG. 1 is a diagram of example encrypted sensitive data with meta-information including a general encryption marker and a specific encryption marker.

FIG. 2 is a diagram of example access control lists and a lookup table.

FIG. 3 is a flow diagram of an example process of access-controlled decryption.

FIG. 4 is a block diagram of an example cryptography system with access-controlled decryption for big data stores.

### DETAILED DESCRIPTION OF THE INVENTION

Before describing in detail embodiments that are in accordance with the invention, it should be observed that the embodiments reside primarily in combinations of encryption and access-controlled decryption. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, or apparatus that comprises a list of elements does not include only those elements but may include other elements not expressly listed or inherent to such process, method, or apparatus. An element preceded by “comprises . . . a” does not, without more constraints, preclude the existence of additional identical elements in the process, method, or apparatus that comprises the element.

Various embodiments of the invention provide a method and system for access-controlled decryption in big data stores, i.e., highly distributed file systems (DFSs). Various embodiments of the invention also provide a system which provides the ability to add markers or other meta-information related to the nature of the sensitive data during the process of encryption. Subsequently, dynamic decryption of encrypted data can be performed by applying access privileges to one or more sensitive data types and to files that contain them by utilizing the methods and system disclosed herein.

In any data store, there are access controls that define which users have access to individual entities such as files and tables, and in what mode. Entities such as files and tables may contain one or more sensitive items. The data may be structured, or unstructured. The method and system disclosed herein provides a solution whereby, for both structured and unstructured data, at the time of encryption, certain markers are stored, which provide meta-information about the item being encrypted. At decryption time, this meta-information is used to determine whether the decryption should be performed or not for a particular user.

In an implementation, the method disclosed here relates to only encrypting the sensitive elements in an entity such as a file or a table, leaving the non-sensitive elements in the clear (unencrypted). In a given scheme, provision is made for remembering which elements were encrypted, so that this information can be used at decryption time. In addition to remembering the elements which were encrypted, meta-information about the elements is also remembered. This meta-information is of a nature that can be used for decrypting based on a user's access rights.

There are different embodiments of the scheme described above. In an embodiment, the entity containing sensitive elements is an unstructured text file residing in a distributed file system such as Hadoop's HDFS or other large scale processing framework for data storage. In this case, a discovery determines which elements of the file are sensitive. The elements found sensitive are encrypted.

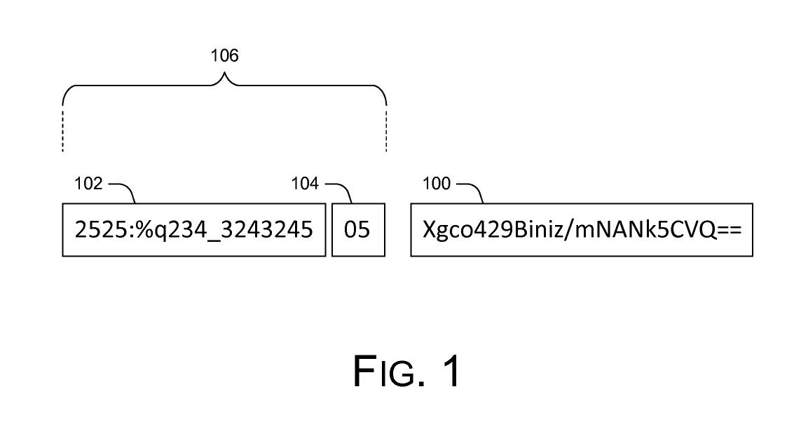

FIG. 1 shows an example encrypted sensitive (data) element 100. In an implementation, an encryption mechanism adds a general encryption marker 102 and a specific encryption marker 104 before (at the front of), or associated with, the encrypted sensitive element 100. In an implementation, the general encryption marker 102 and the specific encryption marker 104 make up metadata, referred to herein as a meta-information marker 106. In an implementation, the general encryption marker 102 is a unique string that has a low probability of recurrence in documents in the file system or subsystem which contains the file that includes the data elements 100 being encrypted. The specific encryption marker 104 contains or consists of an identifier that indicates that the nature of the data element 100 that is being encrypted. This identifier may refer to the sensitive type of the data element 100, or to metadata such as, but not limited to, the times at which it can be accessed, IP addresses from where it can be accessed, or groups within an organization that can access the data element 100.

In an embodiment, the general encryption marker 102 can be a static string corresponding to a particular file system. In such a case, all encrypted elements in the file system can be preceded by the same general encryption marker 102. In another embodiment, the general encryption marker 102 can vary for different parts of the file system, depending on how the file system is being used.

In an embodiment, the specific encryption marker 104 can be a direct identifier that identifies a sensitive item type, class, or category in a 1:1 manner. For example, credit card numbers may be classed as a type, and assigned the identifier “1”, social security numbers may have the identifier “2”, and so forth.

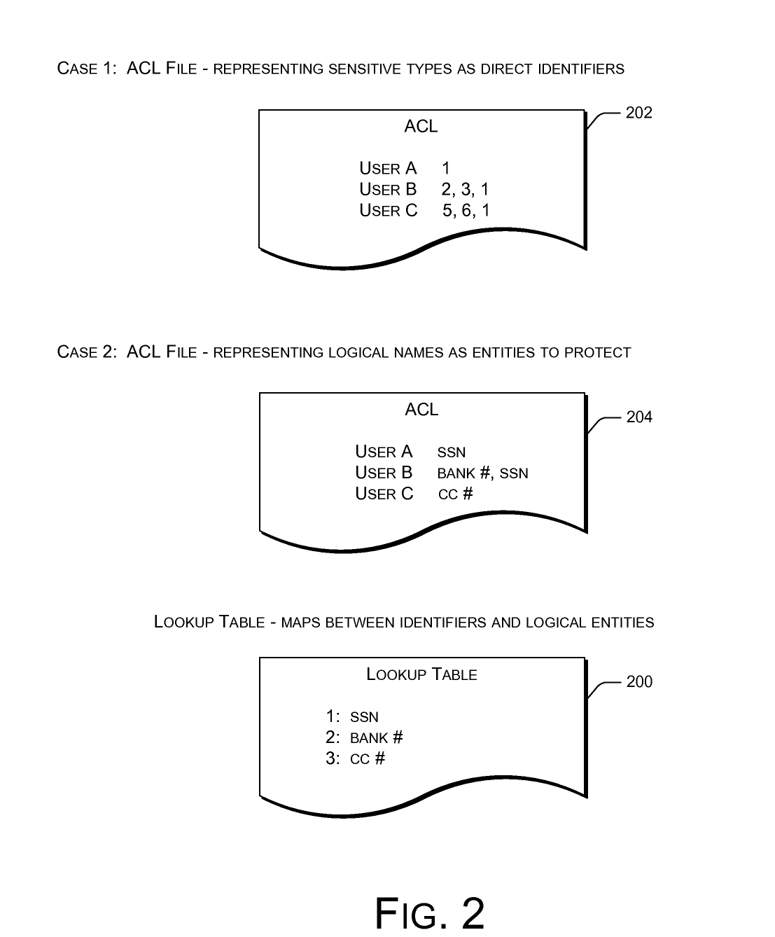

Referring to FIG. 2, in another embodiment, the specific encryption marker 104 may be an index into a separate lookup table 200 that contains the relationship between the value of the specific encryption marker 104 and one or more sensitive item types. For example, if the lookup table 200 has an entry that says identifier “1” is any Personally Identifiable Information (PIO item, a specific encryption marker 104 value of “1” then means that the encrypted item is any of the PII items.

FIG. 2 depicts exemplary scenarios incorporating the specific encryption markers 104. These example scenarios are meant to be representative and not exhaustive. There can be other scenarios of a similar nature that employ the same or similar concepts. The numerical value or ASCII value, for example, of the specific encryption marker 104, either retrieved directly or indirectly via a lookup table 200, can relate to entries in an access control list (ACL) 202 or 204. For example, in a direct implementation of the specific encryption marker 104, if the specific encryption marker 104 has a value of “1” indicating credit card numbers, then the access control list 202 may grant users who have identifier “1” in the access control list 202 permission to access (i.e., decrypt) the credit card numbers, associated with the identifier “1”. When a user who has access to the identifier “1” in the access control list 202 then runs decryption, the system decrypts the credit card data elements for that user. The specific encryption marker 104 may even more directly relate a type of secured data to a particular user via direct logical names as in access control list 204, in which a social security number, for example, uses an actual name or abbreviation, such as “ssn”. The ACL file may also have identifiers corresponding to parameters such as allowed time of access, allowed range of IP addresses from where the access can happen. These identifiers will then correspond to values of the specific encryption marker.

If there is a level of generality or indirection in the assigned specific encryption marker 104, as in the PII example above, then when the access control list 202 has some users given access to the PII information, which in this case refers to identifier “1” in the lookup table 200, then if the specific encryption marker 104 value is “1”, the given element will be decrypted for any user who has access to PII information in general via the specific encryption marker “1”. In another scenario, the lookup table 200 may have complex conditions representing the values of the specific encryption markers 104.

In an embodiment, multiple specific encryption markers 104 are associated with an encrypted sensitive element 100. Once such multiple specific encryption markers 104 are present, they may be interpreted based on rules specified in a lookup table 200 or in the decryption code itself. For example, it may be advantageous for a particular enterprise to allow access to the encrypted item only if the user has access to all of the identifiers represented by the multiple specific encryption markers 104. Or, in another case, even if the user has access to only one of the multiple specific encryption markers 104, then access can be given to the decrypted value associated with these multiple specific encryption markers 104.

In an embodiment, the general encryption markers 102 and specific encryption markers 104 may be associated with an entire record that is encrypted rather than a specific item within the record. Multiple specific encryption markers 104 for the one record may be placed for the record to account for all of the different sensitive types found within that record.

Once the meta-information marker 106 consisting of at least these markers 102 & 104 is associated with the data element 100 that is being encrypted, for example by being stored or placed before or in front of the data element 100, then at decryption time, the decryption mechanism or engine looks for these markers, e.g., marker 102, in the file. Upon finding a general encryption marker 102, the decryption engine concludes that the data element following is to be decrypted. Upon reading the specific encryption marker 104, the decryption engine has an algorithm that interprets the type of the sensitive element 100.

In another embodiment, rather than store both the general encryption marker 102 and the specific encryption marker 104 before the encrypted element 100, another index file or offset table may be created. The term “index file” is used representatively herein to refer to these. The index file can contain pointers to the encrypted data 100 in the file being processed. The index file, in addition to containing pointers to the encrypted elements 100 in the main file being processed, can also contain the specific encryption markers 104 that indicate the type of sensitive data either directly or indirectly as described above. In the index file implementation, the use of general encryption markers 102 is not necessary. The pointers to sensitive data fulfill the purpose of the general encryption markers 102.

In yet another embodiment, if the file or table format permits, the index information is stored in a header or index block instead of in a separate file. The pointers to the sensitive elements 100 are then kept in this header or index block rather than in a separate file or right before the element. The specific encryption markers 104 may be kept in the same header or index block in this case.

In an implementation, if the file is structured, and entire columns or fields are deemed sensitive, then the information regarding the sensitive items 100 need only be stored once per sensitive column rather than for each sensitive data element 100. This also applies to structured file formats commonly used in Hadoop systems, such as Sequence and Avro files.

The specific encryption markers 104 themselves may be protected in various ways, such as encrypting them using separate encryption keys.

Skilled practitioners in the field will recognize that there are many possible embodiments of the above concepts that apply to many different data storage scenarios, depending on the particular technology used to implement the files or tables being encrypted.

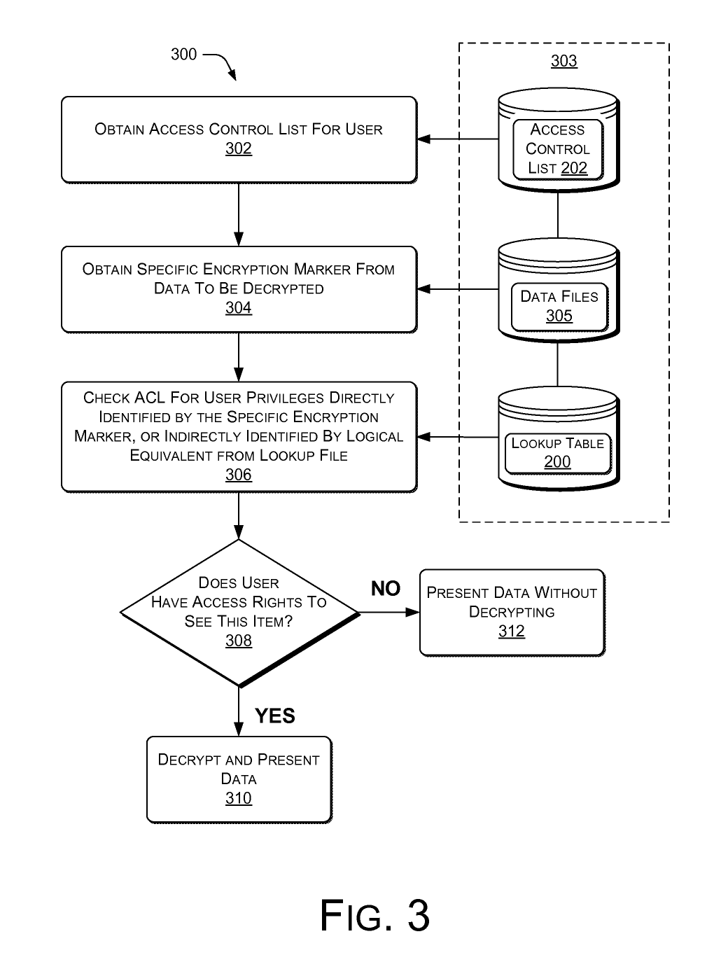

FIG. 3 shows an example decryption process. Once the encryption is completed, then, at decryption time, example decryption processes may proceed with the following. In FIG. 3, the decryption process 300 is shown in individual blocks.

At block 302, an access control list 202 and lookup table 200 (if any) are retrieved from data storage 303 or from memory, and entries for the access rights of the user are obtained. Depending on the technology used, the access control list 202 and lookup table 200 may be kept in files along with other data files 305. For example, in Hadoop file systems, the access control list 202 and lookup table 200 themselves may be encrypted HDFS files. In another implementation, the access control list 202 and lookup table 200 information may be served up by a central service.

At block 304, the data to be decrypted as well as the meta-information marker 106 including one or more specific encryption markers 104 are retrieved from data storage 303.

At block 306, the access control list 202 is checked for a matching presence of the specific encryption markers 104. If there is a lookup table 200, then the specific encryption marker 104 read from the meta-information marker 106 is used to index the lookup table 200 to determine if there is a pointer, label, indirect reference, logical equivalent, condition, or rule in the lookup table 200 that corresponds to the specific encryption marker 104 now indexing the lookup table 200 and that points to an access right of the user in the access control list 202 regarding the sensitive data 100 to be decrypted.

At block 308, if the access control list 202 allows the decryption, then the decryption proceeds, and at block 310 the decrypted data is presented to the user. If the access control list 202 does not allow the decryption, then the decryption does not proceed, and at block 312 the decrypted data is either not displayed or is presented to the user in encrypted form.

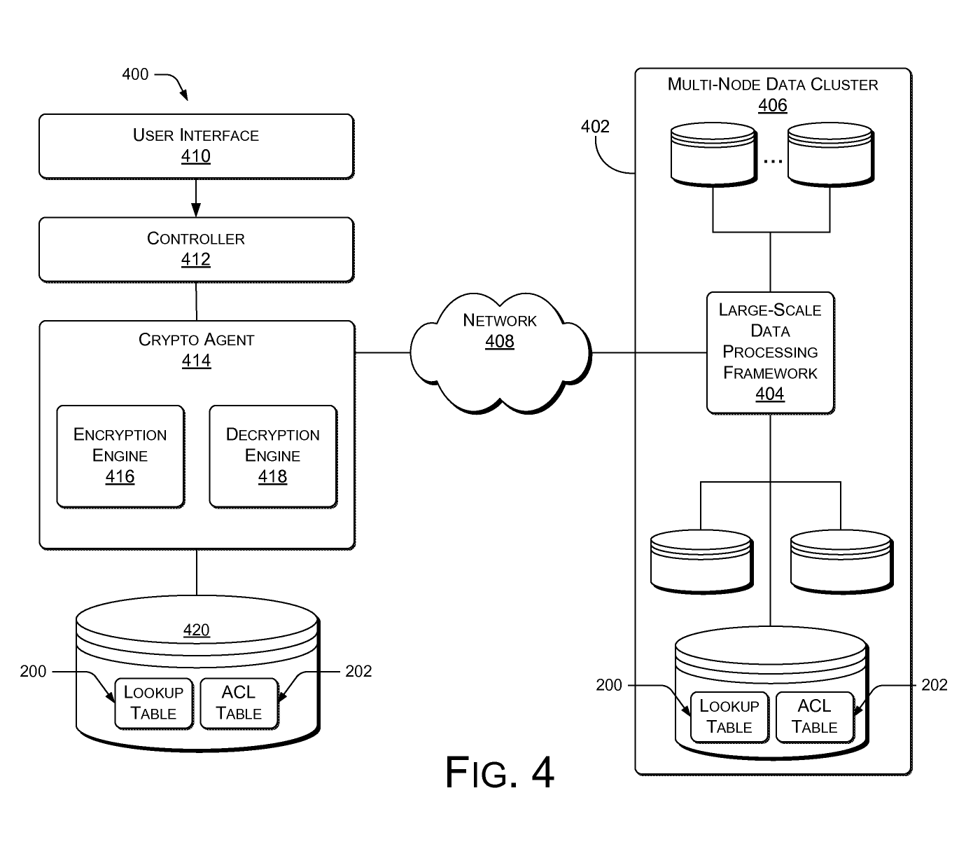

FIG. 4 shows an example cryptography system 400 that performs encryption and decryption with access control on a big data store 402 such as a Hadoop system, or other system with large-scale processing framework 404 and multi-node data clusters 406. The example cryptography system 400 may work over a network 408, such as the Internet or other remote communications net.

A user interface 410 enables the user to initiate encryption and decryption functions, which are then transmitted by a controller 412 to a crypto agent 414 for the big data store 402. An example crypto agent 414 has scalable parallel-processing power to match the bandwidth and capacity of the particular big data store 402. The example crypto agent 414 may include an encryption engine 416 and a decryption engine 418, each applying respective algorithms. In an implementation, the example crypto agent 414 can spawn jobs (such as MapReduce jobs, for example) that perform encryption and decryption on the big data store 402. This depicts only one example, in which decryption is performed by a pre-built program. In FIG. 4, an access control list 202 (or 204) and a lookup table 200, if used, may reside in various storage locations, such as in a controller data repository 420 in the form of database tables, or in the big data store 402 itself. There are other ways of doing decryption, by embedding the decryption into Java MapReduce programs, Apache Hive, and Apache Pig, for example.

The user interface 410 allows the user to initiate discovery of the sensitive data 100, and encryption and decryption actions. These are example actions and others may also be initiated by the user interface 410. For example, the user interface 410 may be used to initiate blocking of a user from accessing any file in the big data store 402.

In an implementation, a user's Java MapReduce program may include a decrypter library that retrieves the specific encryption marker 104 to perform a lookup in the access control list 202, and then decides whether to proceed with the decryption or not.

The various embodiments of the invention provide an efficient method and system for encryption which sets up necessary meta-information 106 for access-controlled decryption, and for performing the access-controlled decryption itself.

Those skilled in the art will realize that the above-recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as critical, or required.

1. A method, comprising:
receiving a request to encrypt a sensitive datum within a large distributed file system (large DFS);
creating meta-information associated with the sensitive datum for determining, for each particular user, whether to decrypt the sensitive datum at a later time;
encrypting the sensitive datum while leaving non-sensitive data of the large DFS unencrypted;
storing the encrypted sensitive data; and
storing the meta-information.

2. The method of claim 1, wherein the sensitive datum comprises one of structured data or unstructured data within a highly distributed file system (DFS) of structured data or unstructured data.

3. The method of claim 1, wherein encrypting the sensitive datum further comprises encrypting a sensitive datum of a file or a table, while leaving non-sensitive data of the file or the table unencrypted.

4. The method of claim 1, wherein storing the meta-information comprises one of storing the meta-information to precede the encrypted sensitive datum on a storage medium, storing the meta-information in a same storage object as a header, or storing the meta-information in a separate storage object from the header, during encryption.

5. The method of claim 1, wherein the meta-information for the sensitive datum in a file includes a general encryption marker and a specific encryption marker;
wherein the general encryption marker comprises a unique string having low probability of recurrence in a file system or in a file subsystem containing the file and is associated with each encrypted datum in the file system or file subsystem; and
wherein the specific encryption marker identifies one of a type of the sensitive datum, a time of access of the sensitive datum, an IP address of an access of the sensitive datum, an identity of one or more groups entitled to access the sensitive datum, or an access parameter associated with the sensitive datum, each particular user having an associated set of access rights to different types of sensitive data.

6. The method of claim 5, wherein the sensitive datum comprises a type selected from the group of types consisting of a credit card number, a social security number, a financial transaction, an account number, personal demographic information, personal identity information, a name, a date of birth, a place of birth, a mother's maiden name, a datum linkable to an individual, personal educational information, employment information, a private weblog, a private message, a certificate, and a private image.

7. The method of claim 6, wherein the specific encryption marker comprises a code to identify the type of the sensitive datum.

8. The method of claim 6, further comprising:
retrieving an access control list for an individual user;
reading the encrypted sensitive datum including the meta-information associated with the encrypted sensitive datum;
reading the general encryption marker of the meta-information to identify the datum as an encrypted sensitive datum;
reading the specific encryption marker to determine a type of the encrypted sensitive datum;
comparing the determined type of the encrypted sensitive datum with the access control list of the user to determine whether to decrypt the encrypted sensitive datum for the user; and
decrypting the encrypted sensitive datum for the user when the access control list of the user entitles the user to access the type of the encrypted sensitive datum.

9. The method of claim 5, wherein the specific encryption marker includes an index to a lookup table containing a relationship between a value of the specific encryption marker and one or more types of the encrypted sensitive data.

10. The method of claim 5, wherein different instances of the general encryption marker are associated with corresponding different parts of a file system.

11. The method of claim 5, wherein multiple specific encryption markers are associated with the encrypted sensitive datum, and further comprising:
interpreting the multiple specific encryption markers based on rules in a lookup table or in a decryption code.

12. The method of claim 5, wherein a user is provided access to the encrypted sensitive datum when the access control list of the user includes entitlement to all of the types associated with the multiple specific encryption markers of the encrypted sensitive datum.

13. The method of claim 12, wherein a user is provided access to the encrypted sensitive datum when the access control list of the user includes entitlement to at least one of the types associated with the multiple specific encryption markers of the encrypted sensitive datum.

14. The method of claim 12, wherein multiple specific encryption markers are associated with encryption of an entire record, and the user is provided access to the entire record according to a scheme selected from the group of schemes consisting of:
a first scheme in which the user is granted access to the entire record when the access control list of the user includes entitlement to at least one of the types associated with the multiple specific encryption markers of the entire record;
a second scheme in which the user is granted access to the entire record when the access control list of the user includes entitlement to all of the types associated with the multiple specific encryption markers of the entire record; and
a third scheme in which the user is granted access to the entire record based on interpreting the multiple specific encryption markers according to one or more rules in a lookup table or in a decryption code.

15. The method of claim 5, further comprising storing the meta-information in an index, an offset file, or a table, wherein the index, offset file, or table includes at least a pointer to the encrypted sensitive datum and to one or more types of the encrypted sensitive datum.

16. The method of claim 15, wherein the index, offset file, or table comprises a header or an index block associated with the encrypted sensitive datum.

17. The method of claim 5, wherein a field, column, row, or a structure of a file or a record comprises at least some sensitive data and the meta-information applies to the access rights of the user to the entire field, column, row, or structure.

18. The method of claim 5, wherein the specific encryption markers are separately encrypted with a different encryption key than an encryption key applied to encrypting the sensitive datum.

19. A system, comprising:
a cryptography engine for creating and accessing secure information in a large distributed data store;
an encryption engine in the cryptography engine for encrypting a sensitive datum in the large distributed data store and creating a meta-information marker for establishing access rights to access the sensitive datum;
a decryption engine in the cryptography engine for reading the meta-information marker to establish access rights for accessing the sensitive datum and for decrypting the sensitive datum when an individual user has access rights;
a user interface for the individual user to initiate discovery, encryption, and decryption actions in the large distributed data store; and
a controller to execute the discovery, encryption, and decryption actions in the large distributed data store via the cryptography engine.

20. The system of claim 19, further comprising:
a general encryption marker in the meta-information marker comprising a unique string having low probability of recurrence in a file system or in a file subsystem and associated with each encrypted datum in the file system or file subsystem; and
a specific encryption marker in the meta-information marker to identify a type of the sensitive datum and to index an access control list, each particular user having an associated set of access rights in the access control list to different types of sensitive data;
wherein the meta-information marker is stored in a permanent storage medium including one of the large distributed data store or a storage repository connected to the controller; and
wherein the decryption engine decrypts the sensitive datum only when the user has access rights based on the specific encryption marker.
